(19) United States
(12) Patent Application Publication
(10) Pub. No.: US 2002/0032799 A1
(43) Pub. Date: Mar. 14, 2002

(54) Deferring DNS service for a satellite ISP system using non-geosynchronous orbit satellites

(75) Inventors: Robert A. Wiedeman, Sedalia, CO (US); Prashant V. Waknis, Mountain View, CA (US)

Correspondence Address: Harry F. Smith, Esq., Ohlandt, Greeley, Ruggiero & Perle, L.L.P., 10th Floor, One Landmark Square,, Stamford, CT, 06901-2682, US

(73) Assignee: Globalstar L.P.

(21) Appl. No.: 09/841,358

(22) Filed: Apr. 24, 2001

Related U.S. Application Data
(60) Provisional application No. 60/201,109, filed on May 2, 2000.

(51) Int. Cl. G06F 15/16

(52) U.S. Cl. 709/245

(57) ABSTRACT

A method is disclosed for operating a satellite telecommunications system, including transmitting a message from a user terminal, the message comprising a Uniform Resource Locator (URL); receiving the message with a satellite, selecting a gateway to receive the message based on the URL, and forwarding the message to the selected gateway; at the selected gateway, performing a Domain Name Service (DNS) query in response to the URL received in the message to obtain an Internet protocol (IP) address of a destination server identified by the URL; and replacing the URL with the IP address and sending the message from the gateway to the destination server having the IP address. The gateway is selected in response to a portion of the URL that identifies a country where the destination server identified by the URL is located, and the message is forwarded to the gateway that serves the identified country. The satellite routes the message to the selected gateway through at least one Inter-Satellite Link (ISL) to at least one further satellite.

### CLAIM OF PRIORITY FROM COPENDING PROVISIONAL PATENT APPLICATION

This application claims priority under 35 U.S.C. 119(e) and 120 from provisional patent application No. 60/201,109, filed on May 2, 2000, the disclosure of which is incorporated by reference herein in its entirety.

### FIELD OF THE INVENTION

These teachings relate generally to satellite-based communication systems and, more particularly, relate to non-geosynchronous orbit satellite communication systems, such as Low Earth Orbit (LEO) and Medium Earth Orbit (MEO) satellite communication systems, as well as to Domain Name Service (DNS) servers.

### BACKGROUND OF THE INVENTION

In U.S. patent application Ser. No. 09/334,386, filed Jun. 16, 1999, entitled “ISP System Using Non-Geosynchronous Orbiting Satellites,” by Robert A. Wiedeman, there are disclosed embodiments of satellite-based communication systems that extend the Internet using non-geosynchronous orbit satellites. A user in a remote location can use the LEO constellation to access the Internet. The satellites in this system become part of the Internet and act as access points for User Terminals (UTs) in remote areas. This U.S. patent application is incorporated by reference in its entirety, insofar as it does not conflict with these teachings.

One of the most frequent operations performed by Internet users is a Domain Name Service (DNS) Query. Typically, the user knows the Uniform Resource Locator (URL) of the site the user wishes to access (such as www.company_name.com). When the user types the URL in a browsing application (such as NetscapeTm), the browsing application makes a query to a DNS server to determine the corresponding Internet Protocol (IP) address. Once the browsing application has the destination IP address, it can then use this address to send IP packets (typically containing data or a request for data) towards the destination. Thus, the Domain Name Service is one of the most often used services when accessing the Internet.

The DNS database is typically stored in hierarchical fashion. The browser in the above example accesses a DNS server. If this DNS server does not have the required IP address, the DNS server searches for the address at another DNS server at a higher level in the DNS hierarchy.

When a user employs a satellite to access the Internet, via a User Terminal (UT), the user may be in a remote area and/or the user may be mobile. When the user desires to access the Internet, and the IP address of the Internet host (destination host) is not known to the UT, the UT must make a DNS query. The DNS query is transmitted to the satellite, and the satellite then sends the DNS query directly to a terrestrial satellite gateway, or the query could be relayed to the gateway through one or more other satellites using Inter-Satellite Links (ISLs). The gateway is connected to at least one terrestrial communication system, such as the Public Switched Telephone Network (PSTN) and/or to a packet data communication network. In any case, the gateway is assumed to be capable of connecting to the Internet or to some other network of interest and, thence, to a DNS or equivalent type of server. The DNS response from the server travels back through the gateway and one or more satellites of the satellite constellation to the UT. The UT, now having the IP address of the destination host, can begin to communicate with the destination host.

As may be appreciated, the operation described above can be time consuming and inefficient. For example, to send a small electronic mail message, the DNS query for the destination IP address may require more time to complete than is required to send the electronic mail message itself This conventional DNS process is clearly inefficient, especially for small messages, and is thus inefficient overall, as most of the messages generated by web browsers are small messages. Typically, these messages contain only a URL, and the total message size is often less than 100 bytes.

### SUMMARY OF THE INVENTION

The foregoing and other problems are overcome by methods and apparatus in accordance with embodiments of these teachings. These teachings provide methods that defer the generation of a DNS query until after a message has been transmitted from a UT and received by a gateway, after which the gateway performs the DNS query on behalf of the UT.

A method is disclosed for operating a satellite telecommunications system, as is a system that operates in accordance with the method. The method includes transmitting a message containing a URL from a user terminal to a satellite, routing the message based on the URL to at least one further satellite or directly to a gateway, receiving the message at the gateway, recognizing that the message contains the URL, and performing a Domain Name Service (DNS) query at the gateway on behalf of the UT to obtain an IP address of a destination server that corresponds to the URL. The message is then transmitted into the Internet and is routed to the destination server based on the IP address.

In a preferred embodiment the user terminal transmits a message containing a Uniform Resource Locator (URL); the message is received with at least one satellite in earth orbit; the message is routed on-board the satellite based on the URL to a selected gateway, and the selected gateway performs a DNS query to a DNS server that is co-located with the gateway, or to a remote DNS server. The message is then further routed after replacing the URL with the IP address returned from the DNS server.

A method is disclosed for operating a satellite telecommunications system, including transmitting a message from a user terminal, the message comprising a Uniform Resource Locator (URL); receiving the message with a satellite, selecting a gateway to receive the message based on the URL, and forwarding the message to the selected gateway; at the selected gateway, performing a Domain Name Service (DNS) query in response to the URL received in the message to obtain an Internet protocol (IP) address of a destination server identified by the URL; and replacing the URL with the IP address and sending the message from the gateway to the destination server having the IP address. The gateway is selected in response to a portion of the URL that identifies a country where the destination server identified by the URL is located, and the message is forwarded to the gateway that serves the identified country. The satellite routes the message to the selected gateway through at least one Inter-Satellite Link (ISL) to at least one further satellite.

### BRIEF DESCRIPTION OF THE DRAWINGS

The above set forth and other features of these teachings are made more apparent in the ensuing Detailed Description of the Preferred Embodiments when read in conjunction with the attached Drawings, wherein:

FIG. 1 is a simplified block diagram of a mobile satellite telecommunications system (MSTS) that is suitable for practicing these teachings;

FIG. 2 is a block diagram of the satellite showing the on-board processor and satellite memory, as well as various communication transceivers;

FIG. 3 is a diagram that is useful in explaining the routing of a message through the system of FIG. 1; and

FIG. 4 is a logic flow diagram depicting a method in accordance with these teachings.

### DETAILED DESCRIPTION OF THE PREFERRED EMBODIMENTS

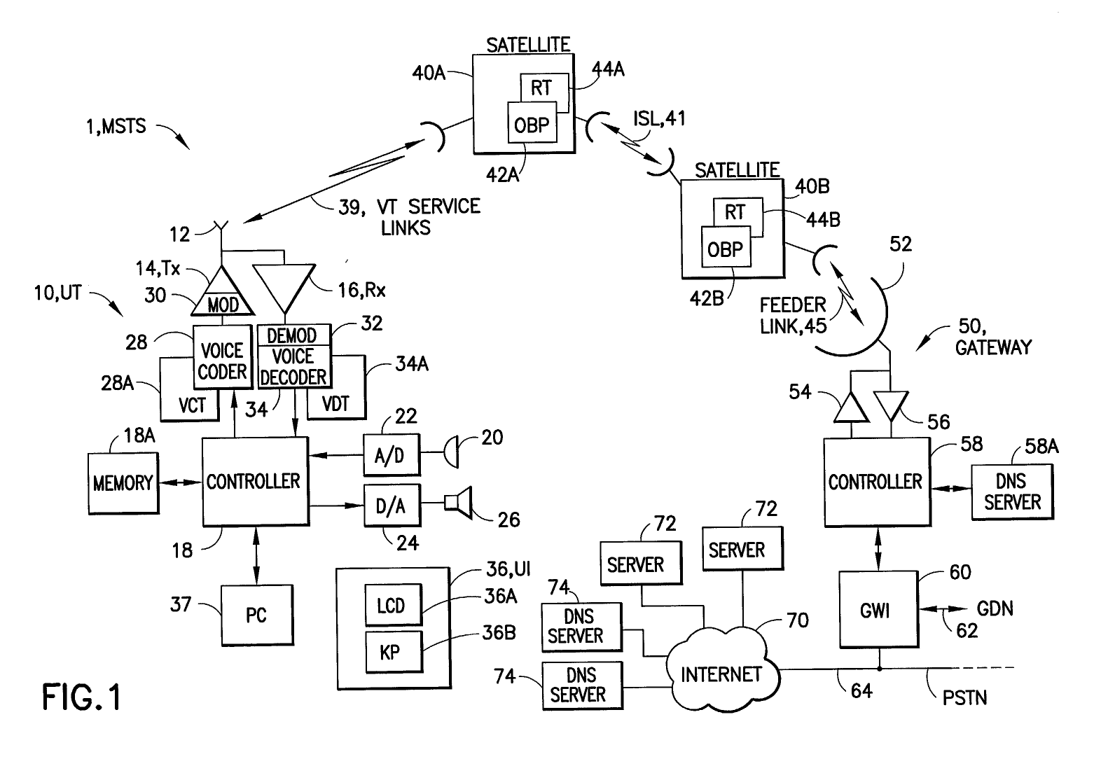

Reference is made to FIG. 1 for illustrating a simplified block diagram of a digital wireless telecommunications system, embodied herein as a mobile satellite telecommunications system (MSTS) 1, that is suitable for practicing these teachings. While described in the context of the MSTS 1, those skilled in the art should appreciate that certain of these teachings may have application to terrestrial telecommunications systems as well.

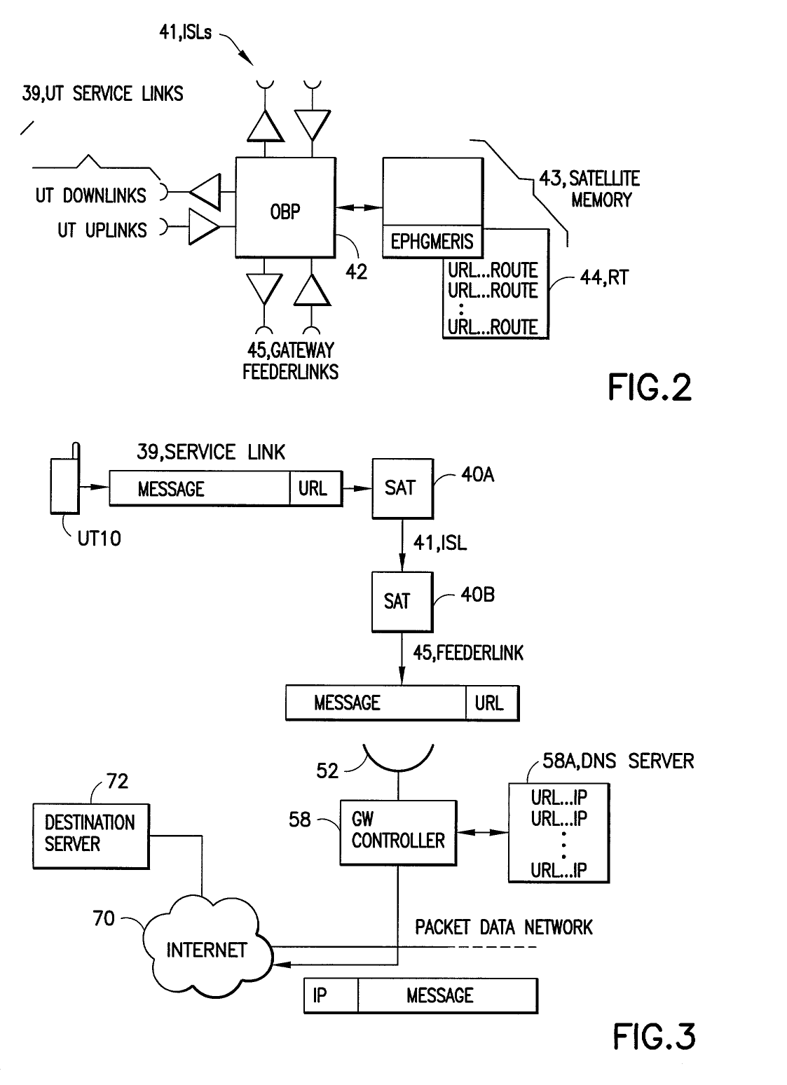

The MSTS 1 includes at least one, but typically many, wireless user terminals (UTs) 10, at least one, but typically several, communications satellite 40, and at least one, but typically several, communications ground stations or gateways 50. In FIG. 1 two satellites are shown for convenience, with one being designated satellite 40A and the other satellite 40B, hereafter collectively referred to as satellite 40. Satellite 40A contains an on-board processor (OBP) 42A and an onboard memory 43 (see FIG. 2) that stores, among other things, a routing table (RT) 44A. Satellite 40B is similarly constructed and contains an OBP 42B and a RT 44B, collectively referred to as OBP 42 and RT 44. An Inter-Satellite Link (ISL) 41 is shown between satellites 40A and 40B. The ISL 41 could be implemented using an RF link or an optical link, and is modulated with information that is transferred between the satellites 40A and 40B, as described in further detail below. More than two satellites 40 can be coupled together using ISLs 41.

Reference with regard to satellite-based communications systems can be had, by example, to U.S. Pat. No. 5,526,404, “Worldwide Satellite Telephone System and a Network Coordinating Gateway for Allocating Satellite and Terrestrial Resources”, by Robert A. Wiedeman and Paul A. Monte; to U.S. Pat. No. 5,303,286, “Wireless Telephone/Satellite Roaming System”, by Robert A. Wiedeman; to U.S. Pat. No. 5,619,525, “Closed Loop Power Control for Low Earth Orbit Satellite Communications System, by Robert A. Wiedeman and Michael J. Sites; and to U.S. Pat. No. 5,896,558 “Interactive Fixed and Mobile Satellite Network”, by Robert A. Wiedeman, for teaching various embodiments of satellite communications systems, such as low earth orbit (LEO) satellite systems, that can benefit from these teachings. The disclosures of these various U.S. Patents are incorporated by reference herein in their entireties, in so far as they do not conflict with the teachings of this invention.

The exemplary UT 10 includes at least one antenna 12, such as an omni-directional antenna or a directional antenna, for transmitting and receiving RF signals over service links 39, and further includes an RF transmitter (TX) 14 and an RF receiver (RX) 16 having an output and an input, respectively, coupled to the antenna 12. A controller 18, which may include one or more microprocessors and associated memories 18a and support circuits, functions to control the overall operation of the UT 10. An input speech transducer, typically a microphone 20, may be provided to input a user's speech signals to the controller 18 through a suitable analog to digital (A/D) converter 22. An output speech transducer, typically including a loudspeaker 26, may be provided to output received speech signals from the controller 18, via a suitable digital to analog (D/A) converter 24. The UT 10 may also include some type of user interface (Ul) 36 that is coupled to the controller 18. The UI 36 can include a display 36A and a keypad 36B. The UT 10 may also be coupled with a computing device, such as a laptop computer or a PC 37, and may thus function as a wireless modem for the PC 37.

A transmit path may include a desired type of voice coder (vocoder) 28 that receives a digital representation of the input speech signals from the controller 18, and includes voice coder tables (VCT) 28a and other required support circuitry, as is well known in the art. The output of the vocoder 28, which is a lower bit rate representation of the input digital speech signals or samples, is provided to a RF modulator (MOD) 30 for modulating a RF carrier, and the modulated RF carrier is upconverted to the transmission frequency and applied to the input to the RF transmitter amplifier 14. Signaling information to be transmitted from the UT 10 is output from the controller 18 to a signaling path that bypasses the vocoder 28 for application directly to the modulator 30. Not shown or further discussed is the framing of the transmitted signal for a TDMA type system, or the spreading of the transmitted signal for a CDMA type system, since these operations are not germane to an understanding of this invention. Other operations can also be performed on the transmitted signal, such as Doppler precorrection, interleaving and other well known operations.

A receive path may include the corresponding type of voice decoder 34 that receives a digital representation of a received speech signal from a corresponding type of demodulator (DEMOD) 32. The voice decoder 34 includes voice decoder tables (VDT) 34a and other required support circuitry, also as is well known in the art. The output of the voice decoder 34 is provided to the controller 18 for audio processing, and is thence sent to the D/A converter 24 and the loudspeaker 26 for producing an audible voice signal for the user. As with the transmitter path, other operations can be performed on the received signal, such as Doppler correction, de-interleaving, and other well known operations. In a manner analogous to the transmit path, received signaling information is input to the controller 18 from a signaling path that bypasses the voice decoder 34 from the demodulator 32.

It is pointed out that the above-mentioned voice and audio capability is not required to practice these teachings, as the UT 10 may operate solely as a data communications device. In this mode of operation the vocoder(s) may simply be bypassed, and the data signals modulated/demodulated, interleaved/de-interleaved, etc. In a data-only application the UT 10 may be constructed so as not to include any analog voice capability at all. Furthermore, in a data-only application the user interface 36 may not be required, particularly if the UT 10 is wholly or partially embedded within another device, such as the PC 37.

The RF signals transmitted from the UT 10 and those received by the UT 10 over the service links 39 pass through at least one satellite 40, which may be in any suitable altitude and orbital configuration (e.g., circular, elliptical, equatorial, polar, etc.) In the preferred embodiment the satellite 40 is one of a constellation of non-geosynchronous orbit (non-GEO) satellites, preferably Low Earth Orbit (LEO) satellites, although one or more Medium Earth Orbit (MEO) satellites could be used as well, as could one or more geosynchronous orbit satellites in conjunction with LEO or MEO satellites. In the preferred embodiment the satellite 40 has the on-board processor (OBP) 42, wherein a received transmission is at least partially demodulated to baseband, processed on the satellite 40, re-modulated and then transmitted. As will be discussed below, in accordance with an aspect of these teachings the on-board processing conducted by the satellite 40 includes routing a received message containing a URL in accordance with routing information stored in the routing table (RT) 44.

The satellite 40 serves to bidirectionally couple the UT 10 to the gateway 50. The gateway 50 includes a suitable RF antenna 52, such as steerable parabolic antenna, for transmitting and receiving a feederlink 45 with the satellite 40. The feederlink 45 will typically include communication signals for a number of UTs 10. The gateway 50 further includes a transceiver, comprised of transmitters 54 and receivers 56, and a gateway controller 58 that is bidirectionally coupled to a gateway interface (GWI) 60. The GWI 60 provides connections to a Ground Data Network (GDN) 62 through which the gateway 50 communicates with a ground operations control center (not shown) and possibly other gateways. The GWI 60 also provides connections to one or more terrestrial telephone and data communications networks 64, such as the PSTN, whereby the UT 10 can be connected to any wired or wireless telephone, or to another UT, through the terrestrial telecommunications network. In accordance with an aspect of these teachings the gateway 50 provides an ability to reach the Internet 70, which provides access to various servers 72 as well as DNS servers 74. The gateway 50 also includes banks of modulators, demodulators, voice coders and decoders, as well as other well known types of equipment, which are not shown to simplify the drawing.

Having thus described one suitable but not limiting embodiment of a mobile satellite telecommunications system that can be used to practice these teachings, reference is now made to FIG. 2 for illustrating the construction of the satellites 40.

The satellite on-board processor 42 is coupled to the routing table 44 stored in satellite memory 43. The on-board processor 42 and the on-board memory 43, in particular the routing table 44, operate to analyze the URL sent by the UT 10. More specifically, the on-board processor 42 is programmed so as to identify a gateway 50 that is closest to a server that is associated with the URL. For example, if the URL is cs.kxvc.ac.jp, then the routing table 44 stored in the on-board memory identifies a route pointing to a gateway 50 that is located in or that serves Japan. If the URL is instead http://company_name.net.in, then a gateway 50 that is located in or that serves India is selected as the gateway that is closest to the server 72 identified by the URL.

As most of the messages transmitted from the UT 10 are small messages (such as connection request to a particular server 72 with a URL identity), these messages may be routed by the satellite(s) 40, using the inter-satellite links 41, to the gateway 50 that is determined to be closest to the desired destination server 72. For example, and referring now also to FIG. 3, if the satellite on-board processor 42 receives a message from a UT 10 that is to be sent to cs.kxvc.acjp, the routing table 44 table stored in the on-board satellite memory 43 identifies the gateway 50 that is located in, or that otherwise serves Japan. Then, based on the satellite constellation ephemeris knowledge stored in the on-board satellite memory 43, the satellite 40A transmits this message to the gateway 50 in Japan, or to an intermediate satellite such as the satellite 40B that currently lies along a route to the gateway 50 in Japan. In this manner the UT 10 can be located anywhere on the earth that has coverage by the MSTS 1, and the message is routed to the gateway 50 that is nearest to the destination server 72 whose URL is found in the message.

From the ephemeris information stored in the satellite memory 43 the OBP 42 has knowledge not only of its own location relative to the surface of the earth, but the locations of others of the satellites 40 of the satellite constellation. In this manner the OBP 42 is enabled to determine whether it is in a position to transmit the message to the gateway associated with the message URL, or whether the message should be transmitted to another satellite 40 for routing to the desired gateway 50. If the message is transmitted to another satellite 40, such as the satellite 40B, then that satellite in turn examines the URL of the message received over the ISL 41, and makes a determination as to whether it should transmit the message to the desired gateway 50, or whether the message should be transmitted over an ISL 41 to yet another satellite 40. Any one of several suitable types of routing algorithms could be executed by the OBP 42 for selecting a next satellite in the gateway route, such as routing algorithms described in the above-referenced U.S. patent application Ser. No. 09/334,386, filed Jun. 16, 1999, entitled “ISP System Using Non-Geosynchronous Orbiting Satellites”. It is also within the scope of these teachings for a satellite 40 to temporarily store or buffer the UT-originated message if, for example, no ISL line of sight currently exists to another satellite, or if the satellite 40 determines that it will shortly be in a position to transmit the message directly to the desired gateway 50.

It can be appreciated that this on-board routing of message traffic is optional, as a satellite 40 may simply transmit a received message directly to any nearest gateway 50, so that after the URL-to-IP address translation occurs the message is delivered in a conventional fashion using the Internet 70. In this case the satellite 40 could be a bent-pipe type of transponder, and may not require that any on-board processing of the UT transmission occur.

Still referring to FIG. 3, once the gateway 50 in Japan receives the connection request message and the associated URL of the destination server 72, the gateway controller 58 performs a DNS query on behalf of the UT 10 to an associated DNS server 58A, locates the corresponding IP address of the server 72, and sends the message (such as a connection request, or an e-mail) to the destination server 72 on behalf of the UT 10. If the gateway 50 does not include the DNS server 58A, or if the DNS query cannot be resolved by the DNS server 58A, then the gateway controller 58 may make a DNS query to another DNS server 74 to obtain the IP address. Once the IP address is available, the message is reformatted by the controller 58 so as to include the IP address, and is forwarded to the PSTN, or directly to a packet data network, using TCP/IP protocols for delivery to the destination server 72 through the Internet 70.

It can be appreciated that there is clearly no need for the UT 10 itself to perform a DNS query before establishing a connection to a desired destination server 72, and a more efficient communication system is thus realized.

These teachings thus employ in one aspect thereof a routing methodology in which the next hop of a message is determined based on the URL (to which a UT 10 has requested the connection) and on the ephemeris knowledge of the satellite constellation. In this methodology, the on-board processor 42 and associated memory 43 of the satellite 40 identifies the destination country, and the nearest gateway 50 serving the destination country, based on the URL received in the message from the UT 10. The message from the UT 10 is then sent to the gateway 50 that is nearest to the destination server 72 based on geographical location. This method avoids a requirement to store a DNS database in the satellite constellation, and defers the DNS query operation to the gateway 50 nearest to the destination server 72.

The gateway 50 thus operates so as to participate in the DNS resolution activity, and DNS server software is incorporated into the gateway 50 in the form of the gateway DNS server 58A, which may be considered as a leaf node in the DNS hierarchy. The gateway DNS server 58A operates to respond to a URL received from the UT 10 to form a DNS query. If the gateway DNS server 58A does not have the IP address of the received URL, then the destination server 72 IP address from another DNS server 74 in the DNS hierarchy.

The UT 10 may include a web browser, or an attached device, such as the PC 37, may include the web browser. For web browsing, instead of first making a DNS query for the IP address of the destination server 72, and then sending the IP address of the corresponding server with the message, the UT 10 instead directly sends to the satellite 40 the URL and the associated message, such as a request to connect to the desired destination server 72. For example, the UT 10 may transmit “www.company name.com.country” to the satellite 40, along with a message requesting connection to the corresponding server 72. The satellite 40 may then route this message to a gateway 50 identified as being a gateway that serves the country identified by the URL. The DNS query for www.company_name.com is then resolved at the gateway 50 using a local DNS server 58A or another DNS server 74 in the DNS hierarchy. The gateway controller 58 then sends the message to establish the connection to the destination server 72 on the behalf of the user of the UT 10. This mode of operation eliminates the time that the UT 10 would spend in communication for making the DNS queries. As was stated earlier, since most messages that a UT 10 initiates are small messages (e.g., about 100 bytes or less), this method proves to be more efficient than having to make a DNS query first from the UT 10.

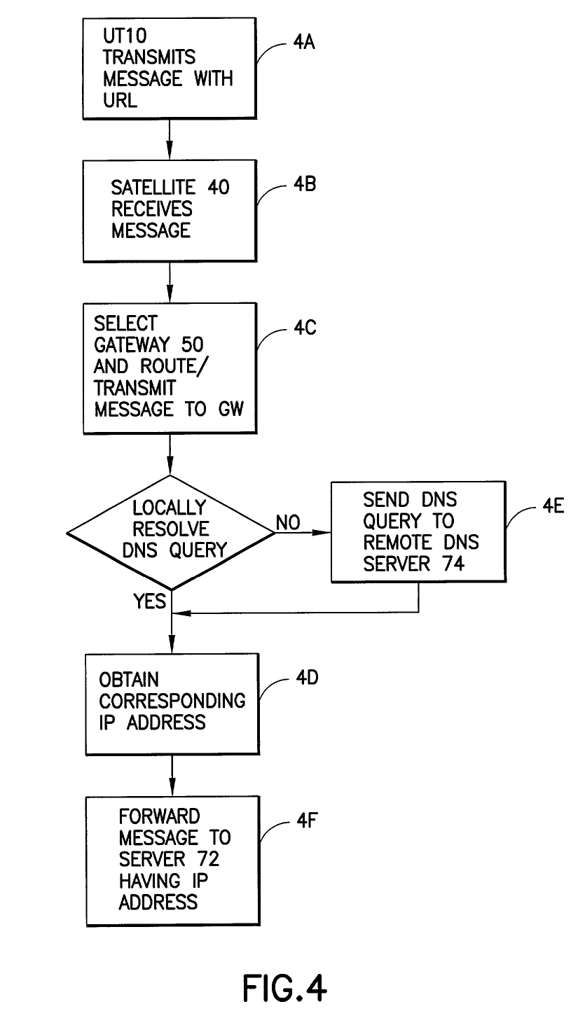

Referring to FIG. 4, in a method provided by these teachings the user terminal 10 transmits a message containing a Uniform Resource Locator (URL) at Block 4A; the message is received with the at least one satellite 40 in earth orbit at Block 4B; the message is optionally routed through another satellite or satellites to a gateway 50 that is selected based on the URL, or the message is transmitted directly to a gateway 50 (Block 4C), and a processor (controller 58) of the gateway 50 generates, in response to the URL, a DNS query to a DNS server 58A and/or 74 to obtain a corresponding Internet Protocol (IP) address (Block 4D). In the event the gateway DNS server 58A is unable to obtain the corresponding IP address, the DNS query is sent to another DNS server 74 at Block 4E. A further operation forwards the message to an Internet destination server 72 having an address that corresponds to the IP address (Block 4F).

These teachings thus provide a non-GEO satellite constellation (e.g., a LEO satellite constellation) that extends the Internet in such a manner that the non-GEO satellites 40 participate in routing message traffic through space based on URLs, and where a terrestrial gateway provides the DNS query function and then forwards the message on to a destination server 72 based on an IP address returned by the DNS query function.

While these teachings have been particularly shown and described with respect to preferred embodiments thereof, it will be understood by those skilled in the art that changes in form and details may be made therein without departing from the scope and spirit of these teachings.

What is claimed is:

1. A mobile satellite telecommunications system, comprising:
at least one user terminal;
at least one satellite in earth orbit; and
at least one gateway bidirectionally coupled to a data communications network;
said at least one gateway comprising a controller for initiating a Domain Name Service (DNS) query in response to a Uniform Resource Locator (URL) received in a message from a one user terminal via said at least one satellite.

2. A mobile satellite telecommunications system as in claim 1, and further comprising a DNS server that is co-located with said gateway.

3. A mobile satellite telecommunications system as in claim 1, wherein said controller receives an Internet Protocol (IP) address in response to said DNS query, and wherein said controller replaces said URL with said IP address and forwards said message to a destination server identified by said IP address.

4. A mobile satellite telecommunications system as in claim 1, wherein said at least one satellite is in a non-geosynchronous orbit.

5. A mobile satellite telecommunications system as in claim 1, wherein said at least one satellite comprises an on-board processor (OBP) that is responsive to said URL for selecting a gateway and for routing said message to said selected gateway.

6. A mobile satellite telecommunications system as in claim 5, wherein said satellite comprises at least one Inter-Satellite Link (ISL) transceiver for routing said message through at least one further satellite.

7. A mobile satellite telecommunications system as in claim 5, wherein said OBP is responsive to a portion of said URL that identifies a geographical region where a destination server identified by said URL is located, and operates to initiate a routing of said message to a gateway that serves said identified geographical region.

8. A mobile satellite telecommunications system as in claim 5, wherein said OBP is responsive to a portion of said URL that identifies a country where a destination server identified by said URL is located, and operates to initiate a routing of said message to a gateway that serves said identified country.

9. A method of operating a satellite telecommunications system, comprising:
transmitting a message from a user terminal, said message comprising a Uniform Resource Locator (URL);
receiving said message with a satellite and forwarding said message to a gateway that is bidirectionally coupled to a data communications network;
at the gateway, performing a Domain Name Service (DNS) query in response to the URL received in the message to obtain a network address of a server identified by the URL; and
sending the message from the gateway to a destination server having the network address.

10. A method as in claim 9, wherein said gateway receives an Internet Protocol (IP) address in response to said DNS query, and replaces said URL with said IP address before transmitting said message to said data communications network.

11. A method as in claim 9, wherein said at least one satellite is in a non-geosynchronous orbit.

12. A method as in claim 9, wherein said satellite is responsive to said URL for selecting a gateway and for routing said message to said selected gateway.

13. A method as in claim 12, wherein said message is routed through at least one Inter-Satellite Link (ISL) to at least one further satellite.

14. A method as in claim 12, wherein said gateway is selected in response to a portion of said URL that identifies a geographical region where a destination server identified by said URL is located, and wherein said message is routed to a gateway that serves said identified geographical region.

15. A method as in claim 12, wherein said gateway is selected in response to a portion of said URL that identifies a country where a destination server identified by said URL is located, and wherein said message is routed to a gateway that serves said identified country.

16. A method of operating a satellite telecommunications system, comprising:
transmitting a message from a user terminal, said message comprising a Uniform Resource Locator (URL);
receiving said message with a satellite, selecting a gateway to receive said message based on said URL, and forwarding said message to said selected gateway;
at the selected gateway, performing a Domain Name Service (DNS) query in response to the URL received in said message to obtain an Internet protocol (IP) address of a destination server identified by the URL; and
replacing the URL with said IP address and sending said message from said gateway to said destination server having said IP address.

17. A method as in claim 16, wherein said gateway is selected in response to a portion of said URL that identifies a country where said destination server identified by said URL is located, and wherein said message is forwarded to said gateway that serves said identified country.

18. A method as in claim 16, wherein said satellite routes said message to said selected gateway through at least one Inter-Satellite Link (ISL) to at least one further satellite.
